(19) United States
(12) Patent Application Publication
(10) Pub. No.: US 2020/0401944 A1
(43) Pub. Date: Dec. 24, 2020

(54) MECHANISM FOR MACHINE LEARNING IN DISTRIBUTED COMPUTING

(71) Applicant: SONY CORPORATION, Tokyo (JP)

(72) Inventors: Henrik SUNDSTRÖM, Södra Sandby (SE); Basuki PRIYANTO, Lund (SE); Andrej PETEF, Lund (SE); Lars NORD, Lund (SE); Anders ISBERG, Åkarp (SE)

(21) Appl. No.: 16/970,479

(22) PCT Filed: Apr. 1, 2019
(86) PCT No.: PCT/SE2019/050297

§ 371 Date: Aug. 17, 2020

(30) Foreign Application Priority Data
Apr. 27, 2018 (SE) 1850507-3

(51) Int. Cl. G06N 20/00; G06N 5/04

(52) U.S. Cl. CPC G06N 20/00; G06N 5/04

(57) ABSTRACT

A method for distributed computation in a hierarchical system having a compute deployment including a plurality of compute nodes, comprising providing a control function communicatively connected to said compute nodes; determining a cost function for the system, which cost function includes at least one first parameter associated with carrying out a compute task and at least one second parameter associated with escalating a compute task; employing a machine learning mechanism in the control function to optimize said cost function; and configuring said compute deployment based on the optimization of the cost function by the machine learning mechanism.

### TECHNICAL FIELD

This disclosure relates to methods and devices for distributed computing, such as for computing estimation output data based on obtained sensor data. More specifically, the solutions provided herein pertain to methods for managing a control function for distributed computation in a hierarchical system having a compute deployment including a plurality of compute nodes, in which machine learning is employed to optimize the system.

### BACKGROUND

With the ever-increasing expansion of the Internet, the variety and number of devices that may be accessed is virtually limitless. Communication networks, usable for devices and users to interconnect, include wired systems as well as wireless systems, such as radio communication networks specified under the 3rd Generation Partnership Project, commonly referred to as 3GPP. While wireless communication was originally set up for person to person communication, there is presently high focus on the development of device to device D2D communication and machine type communications (MTC)/Narrow-band Internet of Thing (NB-IoT), both within 3GPP system development and in other models.

A term commonly referred to is the Internet of things (IoT), which is a network of physical devices, vehicles, home appliances and other items embedded with electronics, software, sensors, actuators, and connectivity which enables these objects to connect and exchange data. It has been forecast that IoT devices will be surrounding us by the billions within the next few years to come, with a recent quote declaring that “By 2030, 500 billion devices and objects will be connected to the Internet.” Hence, one may safely assume that we will be surrounded by more and less capable sensing devices in our close vicinity.

Less capable lower cost IoT devices will typically be deployed at large scale at the network edge, with more capable devices typically being more rarely deployed or having the function of a higher network node. An edge device is a device which provides an entry point into enterprise or service provider core networks. Examples include routers, routing switches, integrated access devices (IADs), multiplexers, and a variety of metropolitan area network (MAN) and wide area network (WAN) access devices. Edge devices may also provide connections into carrier and service provider networks. In general, edge devices may be routers that provide authenticated access to faster, more efficient backbone and core networks. The edge devices will normally be interconnected “vertically” in a peer-to-peer fashion using WAN/LPWAN/BLE/WiFi communication technologies, or “laterally” in mesh, one-to-many, or one-to-one fashion using local communication technologies.

The trend is to make the edge device smarter, so e.g. edge routers often include Quality of Service (QoS) and multi-service functions to manage different types of traffic. However, computation resources may be more powerful in vertically connected compute nodes. As noted, in modern IoT systems, sensor data may be collected in the devices at the edge of the system. The computational power of these edge devices is constrained by limitations of resources such as memory, CPU and energy. In practice, the limitations mean that these devices need to make use of simplified computational models, e.g. simplified Deep Neural Networks. The simplified models are not in all situations sufficient to achieve a “good” (according to some application defined metric) computational result in the edge device itself. Therefore, edge devices have the option to offload computation to more capable devices, further from the edge. These devices may also be resource constrained, with an additional offload option to an even more capable device. This computational hierarchy typically terminates in a cloud server, rich in resources.

FIG. 1 illustrates such a concept for enhancing computation resources, where each box indicates a compute node. The system allows for a node to carry out a compute task, or to escalate the task to a hierarchically higher node. As an example, a compute task may be provided in an edge device 100, and data may be provided for the task to be carried out, such as sensor data from a connected or built-in sensor. Dependent on the compute deployment, the task may be carried out in the edge device node 100, or the task and the data may be escalated 160 from the edge device node 100 to a higher (more capable) compute node 110, 120. Indeed, the compute task may be escalated even after carrying out the compute task, such as based on an outcome of running a prediction or estimation model. The higher node may be an intermediate network node 110, 120 or even a compute node 130 executed in a cloud server. A basic example includes an edge deployed estimation model in a compute node including a sensor device, such as a camera, which based upon its current input may not be able to fulfill its task, such as people counting, to a sufficient level of confidence. The reason may be that the sensor device cannot host a sufficiently complex estimation model given its limited resources, hence for this specific input it decides to transfer the image data to a higher end node 110, which may escalate further to higher nodes 120, 130, and request a more qualitative decision to this estimation task. Transmission in the uplink 160 from the edge device compute node 100 may thus include sensor data and a particular task associated with the data. An improved result, such as e.g. data representing the number of people detected in the image, may thereafter be received 170 in the downlink. This state of the art vertical escalation can be an effective approach, enabling both the deployment of low cost edge devices at scale, and simultaneously means for having a high quality “ground truth” decision when occasionally needed. However, the escalation of sensor data, such as data representing an image, over WAN networks, e.g. a cellular wireless network, might become quite costly since cellular bandwidth may be a scarce resource. Furthermore, the WAN bandwidth can be insufficient, or the connectivity might even be unavailable in non-stationary environments. Additionally, it may be significantly more costly power wise to transfer the data over a WAN network than performing the required compute locally.

However, there still exists a need for improvement it execution of computation in devices, where assistance may be required from other devices to fulfil a certain task. A reason why not all computations are done in the cloud is that there is a cost to offload, in terms of inter alia latency, bandwidth, power consumption, autonomy, privacy protection of data (e.g. computational cost of encryption), security etc. For this reason, it is important to make informed decisions in each compute node about when to offload computations. As an example, it would be valuable in wireless IoT systems in general to find means for limiting both frequency or magnitude of escalations, and alleviation of the need for complex device software for breaking down and aggregating compute tasks and results

### SUMMARY

Based on the aforementioned limitations related to distributed computing, an overall objective is to obtain system improvement. However, most real-world applications are highly dynamic in nature, and it is thus extremely difficult to achieve near-optimal system operation with e.g. statically defined logic and threshold values. Herein, a solution is therefore offered in which system-wide optimization is carried out using a logical control plane, with input and output interface to each compute node, powered by Machine Learning to dynamically optimize distributed computation. The proposed solution is provided in the claims.

According to a first aspect, a method is provided for distributed computation in a hierarchical system having a compute deployment including a plurality of compute nodes, comprising

providing a control function communicatively connected to said compute nodes;

determining a cost function for the system, which cost function includes at least one first parameter associated with carrying out a compute task and at least one second parameter associated with escalating a compute task;

employing a machine learning mechanism in the control function to optimize said cost function; and

configuring said compute deployment based on the optimization of the cost function by the machine learning mechanism.

In one embodiment, the method comprises

receiving first metrics from one or more of said nodes associated with a compute task; and

determining one or more of said first and/or second parameters based on said metrics.

In one embodiment, configuring said compute deployment includes providing compute deployment data to at least one of said nodes.

In one embodiment, configuring said compute deployment includes adjusting a confidence level threshold in one or more of said nodes.

In one embodiment, configuring said compute deployment includes updating a computation model in one or more of said nodes.

In one embodiment, said cost function includes a weight associated to one or more of the first and/or second parameters.

In one embodiment, said first parameter is associated with carrying out a compute task in a node of the system and depends on at least one of confidence threshold values, confidence level of an estimation model output, power consumption, bandwidth utilization, latency, sensor data.

In one embodiment, said second parameter is associated with escalating a compute task between nodes in the system and depends on at least one of latency, bandwidth utilization, power consumption, autonomy, privacy protection, security.

In one embodiment, said machine learning mechanism includes a reinforcement algorithm, the method further comprising, based on the reinforcement algorithm, configured to optimize control function decisions over time to take action to improve a current compute deployment state based on an observed environment including metrics received from said plurality of nodes.

According to a second aspect, a computer program product is provided for managing distributed computation in a hierarchical system having a compute deployment including a plurality of compute nodes, configured to

determine a cost function for the system, which cost function includes at least one first parameter associated with carrying out a compute task and at least one second parameter associated with escalating a compute task;

employ a machine learning mechanism in the control function to optimize said cost function; and

configure said compute deployment based on the optimization of the cost function by the machine learning mechanism.

According to a third aspect, a hierarchical system is provided, comprising a compute deployment including a plurality of compute nodes, and a control function communicatively connected to said compute nodes, wherein said control function comprises a computer program product for managing distributed computation in the hierarchical system, configured to

determine a cost function for the system, which cost function includes at least one first parameter associated with carrying out a compute task and at least one second parameter associated with escalating a compute task;

employ a machine learning mechanism in the control function to optimize said cost function; and

configure said compute deployment based on the optimization of the cost function by the machine learning mechanism.

In one embodiment, the computer program product comprises at least control circuitry, which control circuitry includes a processing device and a data memory holding computer program code, wherein said processing device is configured to execute the computer program code such that the control circuitry is configured to carry out the mentioned steps.

### BRIEF DESCRIPTION OF DRAWINGS

Various embodiments will be described with reference to the drawings, in which

FIG. 1 illustrates a general setup for vertical distribution of compute tasks in a hierarchical system of compute nodes;

FIG. 2 schematically illustrates operation of a compute node in a system of FIG. 1;

FIG. 3 schematically illustrates a device configured to operate as a compute node in accordance with various embodiments;

FIG. 4 schematically illustrates a logical connection between a control function and a compute node in accordance with various embodiments;

FIG. 5 schematically illustrates a logical deployment of a hierarchical system of distributed computation with a control function in accordance with various embodiments;

FIG. 6 schematically illustrates steps carried out by operation of a control function in an embodiment; and

FIG. 7 schematically illustrates an exemplary physical deployment of a system according to an embodiment of a general method.

### DETAILED DESCRIPTION

The invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, when an element is referred to as being “connected” to another element, it can be directly connected to the other element or intervening elements may be present. In contrast, when an element is referred to as being “directly connected” to another element, there are no intervening elements present. Like numbers refer to like elements throughout. It will furthermore be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

Well-known functions or constructions may not be described in detail for brevity and/or clarity. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

Embodiments of the invention are described herein with reference to schematic illustrations of idealized embodiments of the invention. As such, variations from the shapes and relative sizes of the illustrations as a result, for example, of manufacturing techniques and/or tolerances, are to be expected. Thus, embodiments of the invention should not be construed as limited to the particular shapes and relative sizes of regions illustrated herein but are to include deviations in shapes and/or relative sizes that result, for example, from different operational constraints and/or from manufacturing constraints. Thus, the elements illustrated in the figures are schematic in nature and their shapes are not intended to illustrate the actual shape of a region of a device and are not intended to limit the scope of the invention.

In the context of this disclosure, solutions are suggested for optimizing distributed computation in a hierarchical system having a compute deployment including a plurality of compute nodes. In such a system, a compute node may be a device for computing estimation output data, based on an estimation model. With increasing need and capability to push advanced computation to the edge of distributed systems, it will be an important and difficult discipline to decide when computation needs to be offloaded from the edge nodes by escalation. The proposed solutions provide a mechanism for dynamically and adaptively managing this process and keeping system behavior optimal over time.

Computation in a distributed system may typically involve obtaining sensor data, wherein a compute task is to be carried out based on that sensor data, such as a prediction or estimation. The sensor data may e.g. include a characterization of electromagnetic data, such as light intensity and spectral frequency at various points in an image plane, as obtained by an image sensor. The sensor data may alternatively, or additionally, include acoustic data, e.g. comprising magnitude and spectral characteristics over a period of time, meteorological data pertaining to e.g. wind, temperature and air pressure, seismological data, fluid flow data etc.

FIG. 2 schematically illustrates a method or pattern according to which each node of a distributed system may operate according to various embodiments.

In a step S210, a compute node receives input data from a node at a lower level in the hierarchy. For an initial (lowest) node 100, such as an edge device, input is received from one or more attached sensors.

In a step S220, the node may execute a compute task, e.g. by executing a prediction model using the available computational model and resources in that node. The output is a classification decision. A key property of a prediction model is that a “confidence level” value is produced as the output of the executed prediction model. This may be a numerical measure of how certain the model is that the classification is correct.

In a step S230, the method selectively continues dependent on the determined certainty of the classification decision.

If the confidence level is below a threshold value, the node offloads the computation by sending 160 the original input data to a node higher up in the hierarchy in a step S240.

If the task has been escalated in step S240, a response may be received 170 from a higher node in a step S250, including a classification.

In a step S260, a classification has either been deemed certain (or not uncertain) in the node in step S230, or has been received from a higher node in step S250. That classification is thus either used in the node, or otherwise responded to a lower node from which the compute task was escalated. Using the classification may include storing data or metadata related to the original input data.

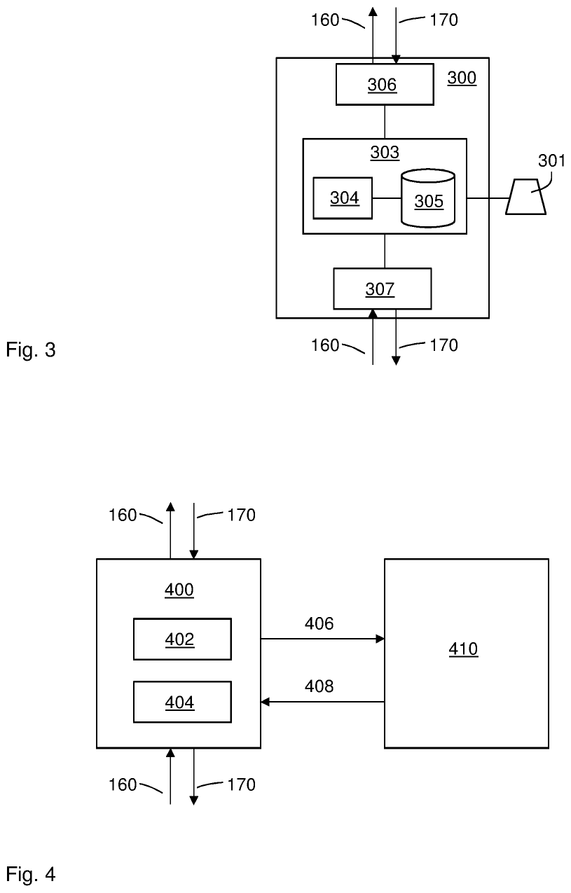

FIG. 3 schematically illustrates a device 300 configured to operate as a compute node, to carry out the method as described for in various embodiments herein. The device 300 may e.g. be an edge device 100, an intermediate node 120, 130 or a cloud server. The device 300 is thus configured to operate as a first device 300 for computing estimation output data based on sensor data. The device 300 may comprise or be connected to one or more sensors 301 for obtaining sensor data. In various embodiments, the device 300 may include said one or more sensors 301 in a common structure or casing. In an alternative embodiment, the device 300 may be connectable to an external sensor 301. The device 300 includes control circuitry 303, which control circuitry 303 may include a processing device 304 and a data memory 305 holding computer program code representing a local estimation model. The processing device 304 may include one or more microprocessors, and the data memory 305 may e.g. include a non-volatile memory storage. The processing device 304 is preferably configured to execute the computer program code such that the control circuitry 303 is configured to control the device to operate as provided in the embodiments of the method suggested herein.

The device 300 may be an edge device 100 of a communication network, such as a WAN, comprising a number of further nodes 110 which have higher hierarchy in the network topology. The device 300 may further be configured to transmit data in uplink 160 and/or the downlink 170 to one or more network nodes of the distributed system. In various embodiments, the device 300 may include a network interface 306 operable to connect the device 300 in the uplink and/or a network interface 307 operable to connect the device 300 in the downlink. The network interfaces 306, 307 may also be different, configured to use different bearers of different communication technologies, such as ZigBee, BLE (Bluetooth Low Energy), WiFi, D2D LTE under 3GPP specifications, 3GPP LTE, MTC, NB-IoT, 5G New Radio (NR), and wired connection technologies.

In one embodiment, the control circuitry 303 is configured to control the device 300 to compute a first estimation score based on first input data obtained either by reception 160 from a lower node, or from a connected sensor 301. The estimation score may be computed using a local estimation model. In the context of this description, an estimation score can take various forms, from numbers, such as a probability factor, to strings to entire data structures. The estimation score may include or be associated with a value related to reliability or accuracy and may be related to a specific estimation task. In various scenarios, this computation may be carried out responsive to obtaining such an estimation task, e.g. to compute an estimation result. Such an estimation task may be a periodically scheduled reoccurring event. In other scenarios, the estimation task may be triggered by a request from another device or network node, or e.g. triggered by receiving first sensor data from the sensor 301. A system, compute node and method according to the embodiments provided herein can apply to sensing data of many sorts, such as image (e.g. object recognition), sound (e.g. event detection), multi-metric estimations, vibration, temperature or even data of less complexity. In the embodiments referred to herein, an estimation model may be one of many classical machine learning models, often referred to under the term “predictive modelling” or “machine learning”, using statistics to predict outcomes. Such models may be used to predict an event in the future but may equally be applied to any type of unknown event, regardless of when it occurred. For example, predictive models are often used to detect crimes and identify suspects, after the crime has taken place. Hence, the more general term estimation model is used herein. Nearly any regression model can be used for prediction or estimation purposes. Broadly speaking, there are two classes of predictive models: parametric and non-parametric. A third class, semi-parametric models, includes features of both. Parametric models make specific assumptions with regard to one or more of the population parameters that characterize the underlying distribution(s), while non-parametric regressions make fewer assumptions than their parametric counterparts. Various examples of such models are known in the art, such as using naive Bayes classifiers, a k-nearest neighbors algorithm, random forests etc., and the exact application of estimation model is not decisive for the invention or any of the embodiments provided herein. In the context of the invention, the estimation model could be a specific design of a Deep Neural Network (DNN) acting as an “object detector”. DNN's are compute-intensive algorithms which may employ millions of parameters which are specifically tuned by “training” using large amounts of relevant and annotated data, which makes them later, when deployed, being able to “detect”, i.e. predict or estimate to a certain “score”, the content of new, un-labelled, input data such as sensor data. In this context, a score may be a measure of the DNN's certainty of a specific classification of the input data. Such an estimation model may be trained to detect objects very generally from e.g. input sensor data representing an image, but typical examples include detecting e.g. “suspect people” or a specific individual. Continuous model adaptation, or “online learning”, where such a model could adapt and improve to its specific environment is complex and can take various forms, but one example is when a deployed model in a device 300 acting as a node 100 can escalate its sensor data vertically to a more capable node 110, 120, 130 with a more complex estimation model, which can provide a “ground truth” estimation and at the same time use the escalated sensor data to re-train the edge device model in the device 300 with some of its recently collected inputs, thereby adjusting the less capable device's 300 estimation model to its actual input.

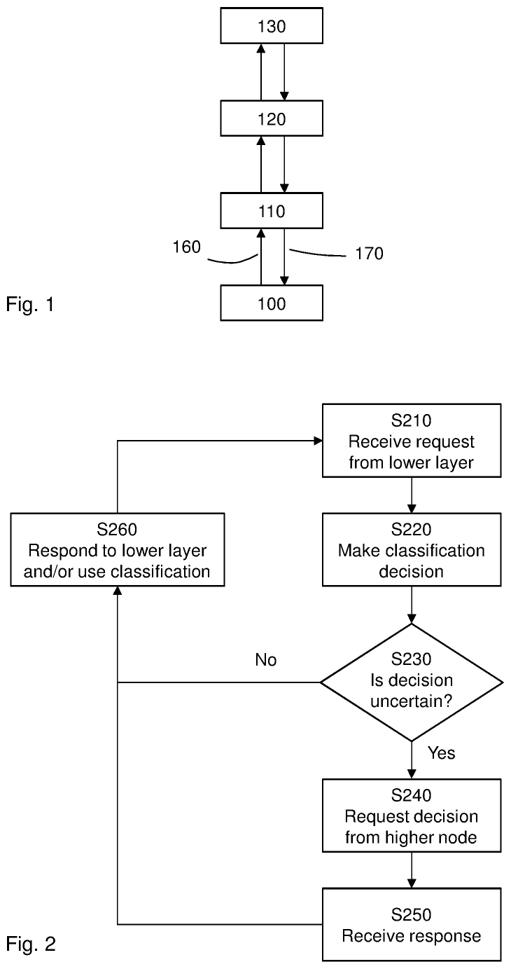

FIG. 4 schematically illustrates a logical representation of a compute node 400, which could be one of the nodes 100, 110, 120, 130 of FIG. 1, and which physically may be configured as outlined with reference to FIG. 3. In accordance with the embodiments presented herein, in addition to executing a compute task and communicating vertically, each node 400 in the computational hierarchy is communicatively connected to a system control function 410, which operates as a logical control backplane in the system. In various embodiments, the node 400 may be configured to employ a neural network 402 function and may send 406 metrics to the control function 410. Such metrics may e.g. be associated with a compute task carried out in the node 400, and information related to whether a compute task originated in the node 400 or was escalated to it. The metrics may also include information and data related to an escalated task and a received response. Examples of metrics may include current reliability threshold values, estimation accuracy such as a confidence level of an estimation model output (could be higher or lower than the threshold), power consumption in the node, bandwidth utilization in up- and downlink, request-response latency, in-device sensor data such as temperature etc.

The information received 406 in the control function from all nodes is fed into a Machine Learning (ML) mechanism of the control function, which is trained to optimize a cost function for the system. The cost function preferably relates to an overall system cost and balances the cost for escalation versus the cost for carrying out a computation task in a node. The cost function may thus include at least one first parameter associated with carrying out a compute task and at least one second parameter associated with escalating a compute task. The ML mechanism may be configured to optimize the cost function on one or more cost parameters, e.g. the overall power consumption of the system, aggregated reliability value output, or the overall system latency. The Control function may further be arranged to configure the compute deployment based on the machine learning mechanism output, which may involve sending 408 compute deployment data to one or more of the nodes of the system. The compute deployment data may include configuration data, such as a new set of confidence level threshold values that are communicated to the nodes for storing in a threshold mechanism 404. Other configuration data may include a change of compute responsibility (i.e. move a specific compute task to a more capable node in the system) or retraining of the neural network 402 function, such as by providing new or adjusted weight factors to an estimation model.

In a preferred embodiment, a Reinforcement Learning algorithm is employed in the control function to continuously optimize its decisions over time. In an active Reinforcement Learning system the agent (here the control function) learns what actions to take (here the changes of compute deployment) to continuously improve its state (here current compute deployment), by observing the environment (here the metrics available from all the nodes) and receiving rewards if a certain property (here the system wide optimization) is improved. Reinforcement learning is as such a known concept.

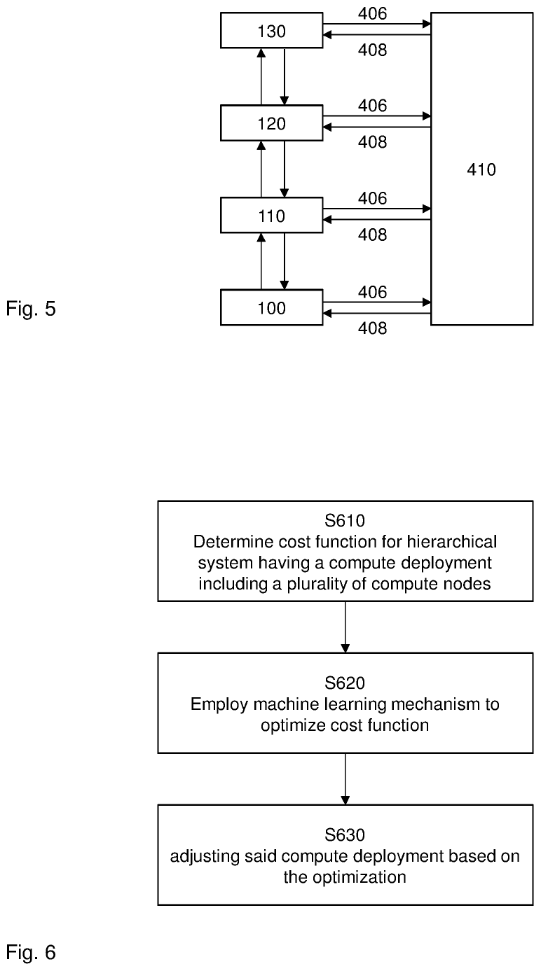

FIG. 5 provides an overall illustration of the proposed method on a logical plane, where a plurality of compute nodes 100, 110, 120, 130 are connected to send 406 data to the control function 410 and receive 408 configuration data for adjustment of the compute deployment and receive. In one embodiment, a global cost function is determined or provided in the cost function 410, which cost function may e.g. be defined as a weighted sum of one or more of the qualitative metrics described herein, which may represent the current optimization of the system and the property to optimize. Whenever the control function makes changes to the specific compute deployment into a new state, a reward would be given to the learning system if that action improved upon the global optimization (i.e. it lowers overall “cost” as observed from the metrics, and vice versa if current status is made worse. As the qualitative metrics can be continuously observed, the control plane can over time, by this interaction with the nodes of the system, learn its optimal policy to take the best action upon any given state or computation task for continuous minimization of the cost function.

For a simple and general cost function model we can define a linear relationship in a weighted sum manner between the “costs” and “advantages” with parameters representing cost entities for executing a task in a node and for escalating the task, as exemplified herein. Using a few of those parameters as an example, the global cost function could be:

$$GlobalCost = {\sum }_{i = 1}^{all compute nodes} ( ( {a}_{i} * LatencyCOst + {b}_{i} * BandwidthCost + {c}_{i} * PrivacyCost ) - ( {d}_{i} * NodePowerConsumption + {e}_{i} * EstimationAccuracy ) )$$

In various embodiments, the actual model used in a system may be more refined and of higher order, and the cost function will typically be system-specific.

With reference to FIG. 6, a general embodiment relates to a method for managing a control function 410 for distributed computation in a hierarchical system having a compute deployment including a plurality of compute nodes 100, 110, 120, 130. The method comprises

a step S610 of determining a cost function for the system, which cost function includes at least one first parameter associated with carrying out a compute task and at least one second parameter associated with escalating a compute task;

a step S620 of employing a machine learning mechanism to optimize said cost function; and

a step S630 of configuring said compute deployment based on the optimization of said cost function by the machine learning mechanism.

One embodiment relates to a computer program product of a control function for managing distributed computation in a hierarchical system having a compute deployment including a plurality of compute nodes, configured to carry out the steps of FIG. 6. The control function may reside a computer program code in or connected to one or more of the nodes of the system, such as in a cloud server 130, or may be distributed in plural nodes. Control signaling 406, 408 with the control function may be carried out over the same physical bearer as the ones used for uplink 160 and downlink 170 communication. The method may involve receiving first metrics from one or more of said nodes associated with a compute task, such as confidence level of an estimation model output, latency, power consumption etc. The method may also include determining one or more of said parameters based on said metrics.

The cost function may include a weighted sum of said first and second parameters. In various embodiments, said cost function includes a first parameter associated with carrying out a compute task in a node of the system, related to at least one of reliability threshold values, confidence level of an estimation model output, power consumption, bandwidth utilization, request to response latency, sensor data. Furthermore, the cost function may include a second parameter associated with escalating a compute task between nodes in the system, related to at least one of latency, bandwidth, power consumption, autonomy, privacy protection, security.

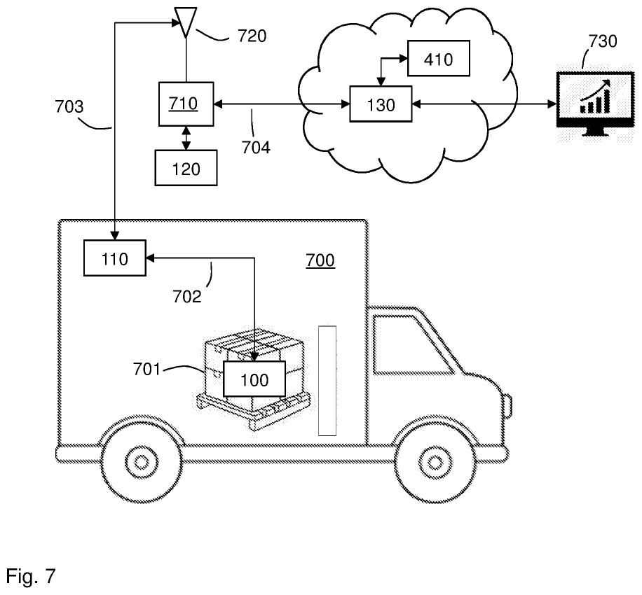

With reference to FIG. 7, one embodiment will now be described, which is usable also for understanding other embodiments and the general concept of the invention. The drawing relates to a use case of detection of potential damage to goods during transportation in a vehicle 700. An item 701, such as goods or a pallet or similar configured for carrying goods, is provided with a sensor 301 which forms part of or is communicatively connected to a node 100. With reference to FIG. 1, the node 100 defines the lowest compute node in a hierarchical system having a compute deployment including a plurality of compute nodes 100, 110, 120, 130. The sensor 301 connected to the node 100 is configured to detect accelerometer data, indicating vibration or shock to the item 701. Based on accelerometer data obtained in the node 100, it is possible to train a model that can detect shocks that are potentially harmful to transported goods. In the example, detection of shock is primarily done in the node 100 device which hosts or is directly connected to the accelerometer. The detection may include executing an estimation model in the node 100 to obtain a score. The compute task in this example may thus be to determine whether or not there is a shock. If the model in the node 100 is uncertain about the classification of an event, i.e. does the sensor data indicate shock, the node 100 can escalate the decision to a gateway node 110 in the same vehicle, which may have better resources for this compute task, such as a stronger model or more processing power. Uplink escalation 160 may be accomplished by e.g. a Bluetooth connection 702 between the node 100 and the node 110. If the decision in the gateway node is also uncertain, further escalation is possible. In the shown example, a radio communication link 703 may be provided between the gateway node 110 and a base station 710, connected to a radio antenna 720, of e.g. an LTE system. A node 120 of the distributed system may further be connected to the base station 710. At the top of the system, a cloud server 130 may be connected to the base station 710 via a core network. A model running on the cloud server 130 may be configured to make a final decision upon escalation. A control function 410 is connected to each distributed node system and may be physically be located in the cloud in connection with or included in the cloud server 130. For this distributed system, a key factor for the mobile node 100 may be to optimize battery life. For the gateway node 110, bandwidth and latency, in particular for uplink communication 703, may be key parameter values to optimize. The “uncertainty”, such as a confidence level, in the example of FIG. 7 is a measure that is produced by the models as a side effect of the decision process. In accordance with the proposed method, a decision whether to escalate or not is determined by a configuration at each level, as provided by the control function. This configuration is dynamically adapted by the ML system, which observes all decision-making and escalation in the full system, as indicated in FIG. 5. If the ML control function e.g. determines that too much LTE bandwidth is being used, the control function may adjust an escalation threshold value in the gateway node 110 to reduce bandwidth utilization.

In general terms, the system, node and method as proposed herein will improve upon a state of the system by utilizing an overall cost function optimized in a control function, which takes input from all nodes of the system. This provides a benefit over the state of the art procedure in which decisions and threshold setting are done in a pure hierarchical manner between nearest nodes. If overall optimizations are needed, then human interaction is necessary in state of the art systems. The solutions proposed herein allow a control function to collect data from all nodes in the system and apply system level Machine Learning as the means to achieve near optimum system performance. By applying reinforcement learning over time this could be accomplished without relying on human interaction.

1. A method for distributed computation in a hierarchical system having a compute deployment including a plurality of compute nodes, wherein each node is configured to execute a respective estimation model to obtain a confidence level of an estimation model output for carrying out a compute task, the method comprising
providing a control function communicatively connected to said compute nodes;
determining a cost function for the system, which cost function includes at least one first parameter associated with power consumption for carrying out said compute task in a first node of said nodes, and at least one second parameter associated with bandwidth utilization for escalating the compute task from the first node to a second node in the hierarchical system;
employing a machine learning mechanism in the control function to optimize said cost function on one or more overall system cost parameters; and
configuring said compute deployment based on the optimization of the cost function by the machine learning mechanism, including adjusting a confidence level threshold to be used by the estimation model in one or more of said nodes.

2. The method of claim 1, comprising
receiving first metrics from one or more of said nodes associated with a compute task; and
determining one or more of said first and/or second parameters based on said metrics.

3. The method of claim 1, wherein configuring said compute deployment includes providing compute deployment data to at least one of said nodes.

4. The method of claim 1, wherein configuring said compute deployment includes adjusting a confidence level threshold in one or more of said nodes.

5. The method of claim 1, wherein configuring said compute deployment includes updating a computation model in one or more of said nodes.

6. The method of claim 1, wherein said cost function includes a weight associated to one or more of the first and/or second parameters.

7. The method of claim 1, wherein said first parameter is associated with carrying out a compute task in a node of the system and depends on at least one metric of the group: confidence threshold values, confidence level of an estimation model output, power consumption, bandwidth utilization, latency, sensor data.

8. The method of claim 1, wherein said second parameter is associated with escalating a compute task between nodes in the system and depends on at least one metric of the group: of latency, bandwidth utilization, power consumption, autonomy, privacy protection, security.

9. The method of claim 2, wherein said cost function comprises a weighted sum of said metrics.

10. The method of claim 1, wherein said machine learning mechanism includes a reinforcement algorithm, the method further comprising, based on the reinforcement algorithm, configured to optimize control function decisions over time to take action to improve a current compute deployment state based on an observed environment including metrics received from said plurality of nodes.

11. The method of claim 1, comprising
receiving a compute task;
controlling a compute node to carry out the received compute task in accordance with the configured compute deployment.

12. The method of claim 11, wherein controlling a compute node to carry out the received compute task includes one of
carrying out the compute task in the compute node in which the compute task was received; or
escalating the compute task from a compute node in which the compute task was received to the compute node controlled to carry out the compute task.

13. A non-transitory computer readable medium storing a computer program product in the form of executable instructions for managing distributed computation in a hierarchical system having a compute deployment including a plurality of compute nodes, wherein each node is configured to execute a respective estimation model to obtain a confidence level of an estimation model output for carrying out a compute task, wherein the executable instructions are configured to
determine a cost function for the system, which cost function includes at least one first parameter associated with power consumption for carrying out said compute task in a first node of said nodes, and at least one second parameter associated with bandwidth utilization for escalating said compute task from the first node to a second node in the hierarchical system;
employ a machine learning mechanism in the control function to optimize said cost function on one or more overall system cost parameters; and
configure said compute deployment based on the optimization of the cost function by the machine learning mechanism, including adjusting a confidence level threshold to be used by the estimation model in one or more of said nodes.

14. A computer system comprising control circuitry, which control circuitry includes a processing device and the non-transitory computer readable medium of claim 13 inclusive of the executable instructions.

15. (canceled)

16. A hierarchical system comprising
a compute deployment including a plurality of compute nodes, wherein each node is configured to execute a respective estimation model to obtain a confidence level of an estimation model output for carrying out a compute task, and
a control function communicatively connected to said compute nodes, wherein said control function comprises a computer program product for managing distributed computation in the hierarchical system, configured to
determine a cost function for the system, which cost function includes at least one first parameter associated with power consumption for carrying out said compute task in a first node of said nodes, and at least one second parameter associated with power consumption for escalating said compute task from the first node to a second node in the hierarchical system;
employ a machine learning mechanism in the control function to optimize said cost function on one or more overall system cost parameters; and
configure said compute deployment based on the optimization of the cost function by the machine learning mechanism, including adjusting a confidence level threshold to be used by the estimation model in one or more of said nodes.

17. (canceled)

18. (canceled)

19. The method of claim 7, wherein said cost function comprises a weighted sum of said metrics.

20. The method of claim 8, wherein said cost function comprises a weighted sum of said metrics.
